(19) United States
(12) Patent Application Publication
(10) Pub. No.: US 2006/0043017 A1
(43) Pub. Date: Mar. 2, 2006

(54) System and method of treating waste water

(76) Inventor: Charles C. Cooley, Cincinnati, OH (US)

Correspondence Address: Mark F. Smith, 905 Ohio Pike, Cincinnati, OH, 45255, US

(21) Appl. No.: 10/925,816

(22) Filed: Aug. 25, 2004

(51) Int. Cl. C02F 3/02

(52) U.S. Cl. 210/629; 210/194; 210/220

(57) ABSTRACT

The present invention relates to a system and method of waste water treatment. In a preferred embodiment of the invention, the system comprises a frame, a pump supported in the frame for directing a portion of the waste water slurry stored within a treatment tank to an aerator apparatus effective for injecting reactive gas, such as air or oxygen, into the waste water to form an activated slurry, and out through a nozzle for introducing and directing the activated slurry into the waste water. Preferably, the activated slurry is ejected into the waste water in such a manner as to cause a circulatory flow of waste water within the treatment tank and for reducing the tendency of sedimentation of solids along the bottom of the treatment tank.

### BACKGROUND OF THE INVENTION

The present application relates to waste water treatment and, more particularly, to a new and novel system and method of treating waste water by aeration.

Waste water from municipal sewage or industrial waste systems is treated prior to release to the environment to meet the strict standards for water discharge quality. Further, certain industrial waste water must be pretreated before being discharged into municipal sewage systems or substantial surcharges are often paid to the municipality for acceptance and treatment of the waste water.

The amount of waste water being generated by a municipality or a particular industrial location can vary greatly depending on such factors as the amount and rate of rainfall, surface runoff from melting snow, increases in population, and industrial activity, to name a few. As a result, at some locations waste water is often stored prior to waste treatment. Such storage systems, as well as the performance of making repairs or conducting routine maintenance, can be significantly expensive. Accordingly, it would be useful to be able to provide a portable waste water treatment system which can be transported to various locations requiring temporary waste water treatment operations or additional waste water treatment capacity and will provide greater aeration of waste water than conventional systems.

Typical methods of storing waste water prior to treatment can and often produces odors. Oxygen is typically supplied to the waste water to prevent odors from being formed by the decomposition of organic waste. One of the most important characteristic of an effective aeration of waste water is its ability to effect aeration by continuously suspending solids in the storage tank and to prevent the sedimentation of the solids along the bottom. Thus, typical water treatment and storage systems often have mixing or agitation devices that operate near the bottom of the treatment tank. Unfortunately, such devices often require maintenance or repairs that necessitate the draining of the treatment tank before maintenance or repairs can be initiated.

Therefore, it would be desirable to have a method and a system for treating stored waste water that supplies an appropriate amount of oxygen to the waste water to prevent septic odors, that continuously suspends solids within the activated slurry and prevents solid sedimentation, and which can be easily maintained and repaired. It would also be desirable to have a system of waste water storage and treatment that can be easily transported and/or installed at locations requiring waste water storage and treatment thereby reducing or eliminating the need for maintaining expensive backup systems or holding tanks.

### SUMMARY OF THE INVENTION

The present invention is a new and novel system and method of treating waste water by aeration. Preferably, the method of the present invention uses a system that is compact and relatively inexpensive to manufacture and operate.

The system of the present invention comprises a frame, a pump supported on the frame for directing a portion of the waste water slurry stored within a treatment tank to an aerator apparatus effective for injecting a reactive gas, such as air or oxygen, into the waste water slurry to form an activated slurry, and out through a nozzle assembly for introducing and directing the activated slurry into the waste water slurry. Preferably, the nozzle assembly is effective for directing the activated slurry into the waste water slurry in a direction to cause a circulatory flow of the waste water slurry within the treatment tank and for reducing the tendency of sedimentation of solids along the bottom of the treatment tank.

In another preferred embodiment of the invention, the aerator apparatus is a venturi aerator.

In another preferred embodiment of the invention, the frame is removably attached to the treatment tank.

In another preferred embodiment of the invention, the frame includes a hook for removably hooking onto the side wall of a treatment tank and for supporting the system of waste water treatment in a proper position within the tank.

In another preferred embodiment of the invention, the frame is adjustable for properly positioning of the system of waste water treatment in proper position within the treatment tank.

In another preferred embodiment of the invention, the nozzle assembly comprises a plurality of injectors for directing the activated slurry in a desired direction to cause a circulatory flow of the waste water slurry within the treatment tank and for reducing the tendency of sedimentation of solids along the bottom of the treatment tank.

In another preferred embodiment of the invention, the system of waste water treatment is portable and can be transported to locations requiring waste water treatment.

In another preferred embodiment of the invention, the method of treating waste water comprises the steps of transporting a system of waste water treatment and attaching the system to the side of a treatment tank, wherein the system of waste water treatment comprises a frame, a pump supported on the frame for directing a portion of waste water slurry stored within a treatment tank to an aerator apparatus for injecting air into the waste water slurry to form an activated slurry, and out through a nozzle assembly effective for introducing and directing the activated slurry back into the waste water slurry.

Various other objects, advantages, and embodiments of the invention will be apparent from the following description, the accompanying drawings, and the appended claims.

### BRIEF DESCRIPTION OF THE DRAWINGS

To provide a more complete understanding of the present invention and further features and advantages thereof, reference is now made to the following description taken in conjunction with the accompanying drawings, in which:

FIG. 1 is a schematic representation of the preferred embodiment of the system of treating waste water of the present invention, the apparatus being shown mounted to the side of a conventional treatment tank;

FIG. 2 is a schematic representation of the system of FIG. 1 mounted on the side of the treatment tank and illustrating the flow of liquid sewage the treatment tank;

FIG. 3 is a detailed schematic representation illustrating the nozzle assembly of the waste treatment system of FIG. 1;

FIG. 4 is a cross-sectional view of a preferred embodiment of an aerator apparatus of the system for the treatment of waste water of FIG. 1;

FIG. 5 is a schematic representation of another preferred embodiment of the system for treating waste water of the present invention showing the system being placed into position on a conventional treatment tank;

FIG. 6 is a flow chart of a preferred embodiment of the method for treating waste water of the present application;

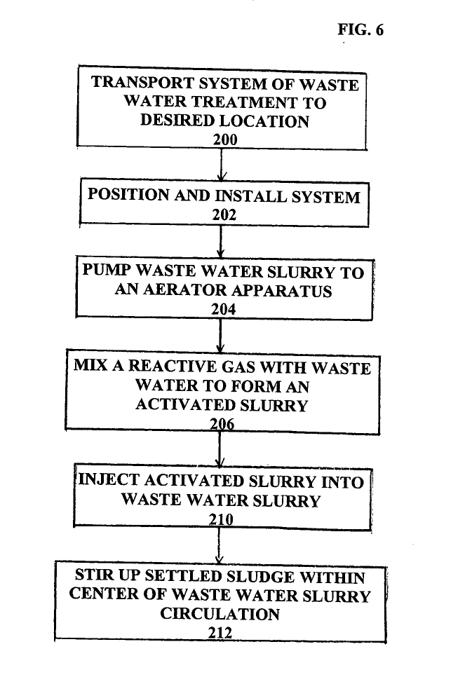

FIG. 7 is a schematic representation of another preferred embodiment of the system for treating waste water of the present invention illustrating telescoping side rails for adjusting the frame.

### DESCRIPTION OF A PREFERRED EMBODIMENTS

The present application relates to waste water treatment and, more particularly, to a system and method of stored waste water treatment. In describing the preferred embodiments of the invention illustrated in the drawings, specific terminology will be resorted to for the sake of clarity. However, the invention is not intended to be limited to the specific terms so selected, and it is to be understood that each specific term includes all technical equivalents that operate in a similar manner to accomplish a similar purpose.

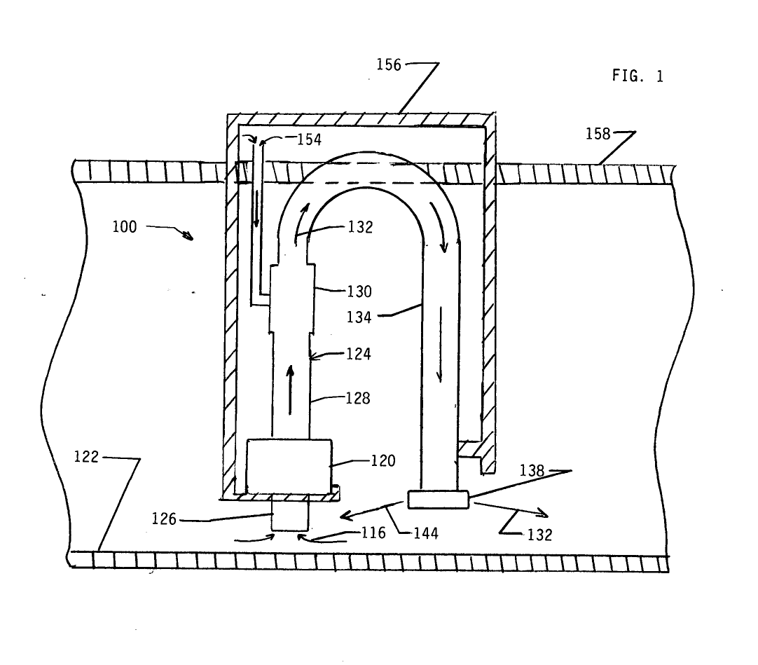

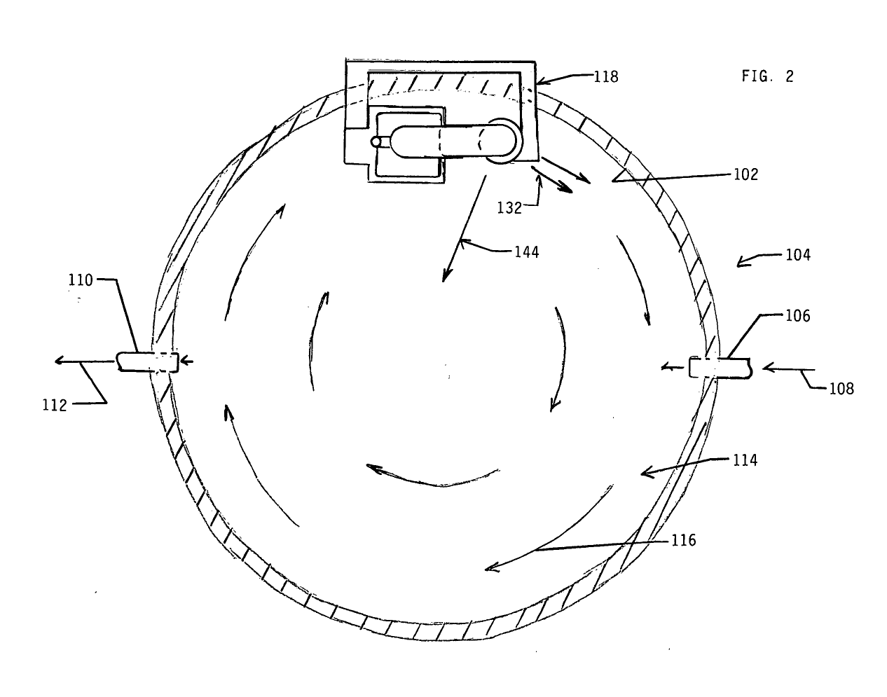

Referring to FIGS. 1 and 2, the system of stored waste water treatment, generally referred to as 100, is show attached to the side wall 102 of a treatment tank 104. The treatment tank 104 can be constructed of various materials including steel, concrete, plastic, or other materials, as is known in the art. The treatment tank 104 includes an inlet port 106 for receiving waste water 108 and an outlet port 110 for discharging activated waste water slurry 112. The inlet port 106 and the outlet port 110 are each in fluid communication to a main chamber 114 containing the waste water slurry 116 to be treated.

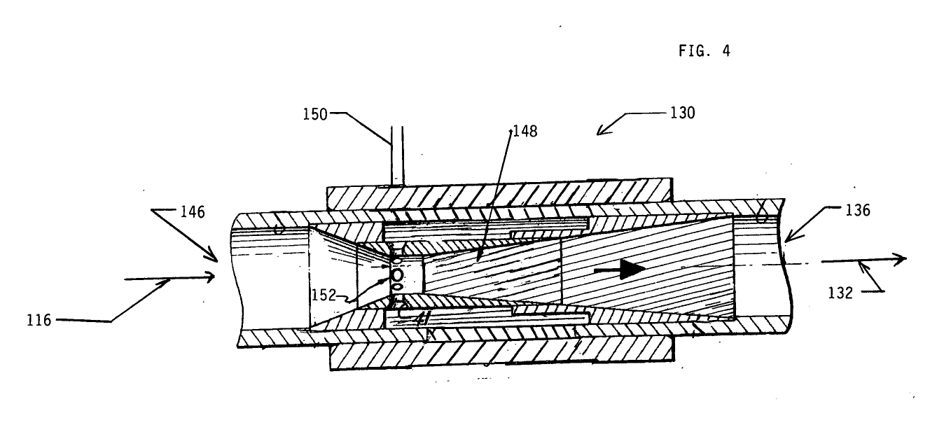

As shown, the system of stored waste water treatment 100 comprises a frame 118 for supporting a pump 120 thereon. Preferably, the pump 120 is a self priming submersible pump and is positioned a short distance from the bottom 122 of the main chamber 114 of the treatment tank 104. It should be understood, however, that other types of self priming pumps including vertical turbine pumps and centrifugal pumps may be used. It should also be understood that the pumps may be positioned such that they are submerged within in the waste water slurry or are positioned outside the waste water slurry. A vertically oriented tube 124 is attached to the frame 118 and includes a first portion having an inlet 126 for receiving waste water slurry 116 from the main chamber 114 of the treatment tank 104 and a first conduit 128 for directing the received waste water slurry 116 from the inlet 126 to an aerator apparatus 130 effective for injecting a reaction gas, such as oxygen or air, into the waste water slurry 116 to form an activated slurry 132. A second portion of the vertically oriented tube 124 includes a second conduit 134 connected to the outlet 136 (FIG. 4) of the aerator apparatus 130 and directs the activated slurry 132 from the aerator apparatus 130 to a nozzle assembly 138 for discharging the activated slurry 132 into the main chamber 114 of the treatment tank 104

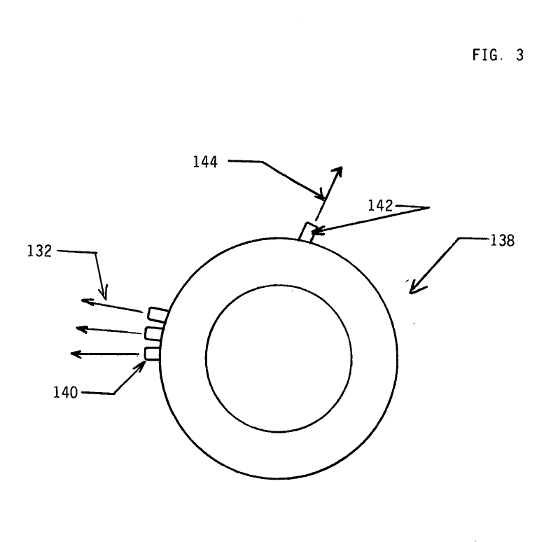

As illustrated in FIGS. 1, 2, and 3, the nozzle assembly 138 of the system of stored waste water treatment 100 is located a short distance from the bottom 122 of the main chamber 114 of the treatment tank 104 and includes a plurality of injectors 140 for injecting the activated slurry 132 into the waste water slurry 116 in the main chamber 114 of the treatment tank 104. Preferably, the injectors 140 are arranged so as to point in the direction effective for causing the momentum of the ejected activated slurry 132 to create a circulatory flow of the waste water slurry 116 in the main chamber 114 (FIG. 2). It should be apparent to those skilled in the art that such circulatory flow will generate a bottom scouring action which will help reduce or prevent the sedimentation of solids along the bottom 122 of the main chamber 114 of the treatment tank 104 thereby increasing aeration effectiveness of the waste treatment system 100. Further, the injectors 140 improve oxidation by increasing the interfacial area by atomizing the oxygen contained within the activated slurry 132.

In another preferred embodiment of the invention, at least one of the injectors 142 is directed radially outwardly in a direction towards the center of the treatment tank 104 to inject a stream 144 of activated slurry 132 in a direction to reduce or prevent the sedimentation of solids from forming within the center of the waste water circulation.

Preferably, the aerator apparatus 130, as shown in FIG. 4, is formed having an inlet 146, an outlet 136, and a throat section 148 such that the cross-sectional area of the throat section 148 is less than the cross-sectional area of the inlet 146 and the outlet 136. Accordingly, the waste water slurry 116 flowing through the throat section 148 will create a venturi effect causing the fluid pressure within the throat section 148 to be less than the fluid pressure at the inlet 146 and the outlet 136. A tube 150 is provided in flow communication with the throat section 148 by a plurality of openings 152 and with a reactive gas source 154 (FIG. 1), such as the outside air. In operation, the low pressure within the throat section 148 will cause reactive gas to flow through tube 150 and openings 152 and mix with the waste water slurry 116 to form an activated waste water slurry 132.

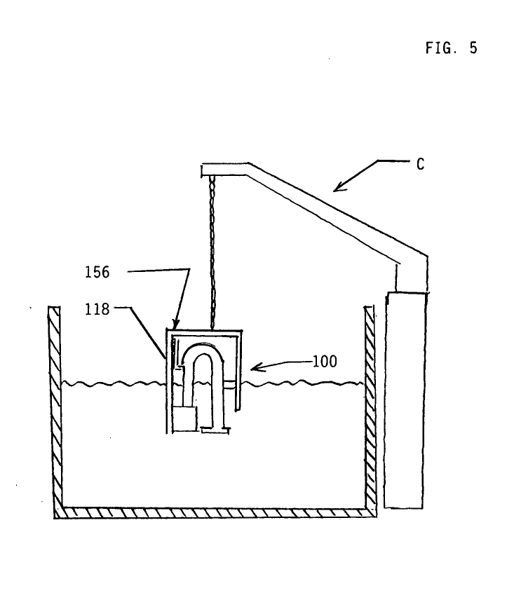

Referring to FIGS. 1 and 5, as shown the system of waste water treatment 100 is attached to the side wall 102 of the treatment tank 104 by the frame 118 having an upper section forming a hook 156 for removably attaching onto the rim 158 of the treatment tank 104 and a lower support 160 for attaching to and supporting the pump 120 in its proper position within the main chamber 114. The frame 118 is also adapted for mounting the vertical orientated tube 124, the aerator apparatus 130, and the nozzle assembly 138 thereby forming a unitary compact structure. In this way, the system of waste water treatment 100 can be easily lifted, such as by a crane or lift C, in order to make repairs or perform routine maintenance, or can be readily transported to locations requiring treatment. It should also now be apparent to those skilled in the relevant art that during times of making repairs or performing routine maintenance, another such system of waste water treatment can be easily installed thereby reducing or eliminating any interruption in waste treatment.

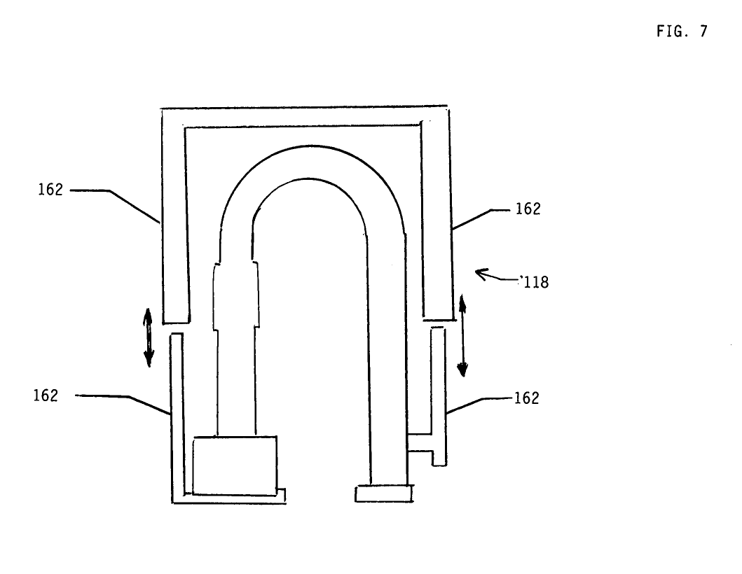

In order to better understand how the features of the described hereinabove are interrelated, the operation of a preferred embodiment of the system and the method of waste water treatment of the present application will now be described. The functional operation of the system of waste water treatment 100 of the present invention can be explained first with reference to FIGS. 1 through 5. The system of waste water treatment 100 is shown after being transported, by a truck or other conventional transportation means (step 200), being positioned and installed along the side of a conventional treatment tank 104 such as by use of a conventional crane C, as shown (step 202). As shown (FIG. 1), the hook 156 portion of frame 118 is placed over the rim 158 of the treatment tank 104 in a manner so that it is supported along the inside side wall 102 of the treatment tank 104. In a preferred embodiment of the invention, the frame 118 is designed for the particular treatment tank 104 such that the pump 120 will be properly positioned near the bottom 122 of the tank 104. In another preferred embodiment of the invention, the frame 118 is adjustable, such as, for example, by constructing the frame 118 using telescoping side rails 162, such as illustrated in FIG. 7. Using pump 120, the waste water slurry 116 within the treatment tank 104 is pumped into inlet 126 through the first portion of vertical oriented tube 124, through first conduit 128 to aerator apparatus 130 (step 204) where reactive gas, such as air, is mixed with the somewhat turbulent waste water slurry 116 forming an activated slurry 132 (step 206). The activated slurry 132 is then directed through second conduit 134 and out through the nozzle assembly 138 where it is injected into the waste water by injectors 140 (step 208). Injectors 140 operate to inject the activated slurry 132 into the waste water slurry 116 in the treatment tank 104 such that the momentum of the ejected activated slurry 132 creates a circulatory flow of the waste water slurry 116 in the main chamber 114 (step 210). Preferably some of the activated slurry 132 is injected radially outwardly, such as by injector 142, towards the center portion of the treatment tank 104 to stir up any settled sludge that may form within the center of the waste water slurry circulation (step 212). The activated slurry 132 then mixes with the waste water slurry 116 where it aerates the waste water slurry 116 circulating within the treatment tank. The process continues until the waste water slurry 116 is adequately aerated and discharged from the treatment tank through outlet port 110.

It should now be apparent to those skilled in the art that for performing repairs and/or maintenance, the system of waste water treatment of the present invention can be easily removed from the treatment tank using a standard crane or other such means thereby eliminating the need to drain the treatment tank. It should also now be apparent to those skilled in the art that the system of waste water treatment is easily transported and installed. In this way, a second system can be easily installed during times of repairs and/or maintenance thereby permitting continuous waste treatment operations. In addition, it should now be apparent that the system of waste water treatment of the present invention can be easily transported and installed at locations where permanent or temporary increase in waste treatment capacity is needed.

The present invention is a new and novel method and apparatus for performing the method of treating waste water whereby waste water is aerated to form an activated slurry and further operates to maintain solids in suspension while allowing the reactive gas within the activated sludge to mix with the waste water slurry within the treatment tank. It has been found that the system of waste water treatment of the present invention allows for a relatively high level of aeration thereby significantly reducing or eliminating undesirable smells and odors and the need to cover the treatment tank. It should also now be apparent to those skilled in the art that the method for treating waste water of the present invention provides for an appropriate amount of reactive gas, such as air or oxygen, to mix with the waste water, that continuously suspends solids within the waste water and prevents solid sedimentation, and reduces undesirable smells and odors.

I claim:

1. A system for treating waste water comprising:
a frame;
a pump supported on said frame;
an aerator apparatus supported on said frame; and
a nozzle assembly supported on said frame;
wherein said pump is effective for pumping waste water to said aerator apparatus for mixing with a reactive gas to form an activated slurry and for pumping said activated slurry to said nozzle assembly for ejecting the activated slurry into the waste water.

2. The system of claim 1 wherein said pump is a self priming pump.

3. The system of claim 1 wherein said aerator apparatus is a venturi aerator.

4. The system of claim 1 wherein said frame is adapted for attaching to the side of a treatment tank.

5. The system of claim 4 wherein said frame is adjustable for adjusting the vertical position of the pump and the nozzle assembly along the side of the treatment tank.

6. The system of claim 4 wherein said nozzle assembly comprises at least one injector effective for creating circulatory flow of waste water within the treatment tank.

7. The system of claim 6 wherein said nozzle assembly comprises at least one injector effective for reducing the sedimentation of solids from forming within the center of the waste water circulation.

8. A system of waste water treatment comprising:
a frame and a pump supported on said frame for directing a portion of the waste water stored within a treatment tank to an aerator apparatus effective for injecting a reactive gas into the waste water to form an activated slurry, and out through a nozzle assembly effective for introducing and directing the activated slurry into the waste water;
wherein, said nozzle assembly is effective for directing the activated slurry into the waste water in a direction to cause circulatory flow of the waste water within the treatment tank and for reducing the tendency of sedimentation of solids along the bottom of the treatment tank.

9. The system of claim 8 wherein said aerator apparatus is a venturi aerator.

10. The system of claim 8 wherein the frame is removably attached to the treatment tank.

11. The system of claim 8 wherein said frame is adjustable for adjusting the vertical position of the pump and the nozzle assembly along the side of the treatment tank.

12. The system of claim 8 wherein said frame includes a hook for placing over the rim of the treatment tank for removably attaching said frame to the treatment tank.

13. The system of claim 8 wherein said system for treating waste water is a unitary structure.

14. A method for treating waste water comprising the steps of:
transporting a system for treating waste water to a desired location; and
placing the system for treating waste water in position for treating waste water;
wherein said system for treating waste water comprises a frame and a pump supported on said frame for directing a portion of the waste water to be treated to an aerator apparatus effective for injecting a reactive gas into the waste water to form an activated slurry, and out through a nozzle assembly effective for introducing and directing the activated slurry into the waste water.

15. The method of claim 14 wherein the system for treating waste water is positioned and installed along the side of a treatment tank.

16. The method of claim 14 further comprising the step of adjusting the vertical position of the system for treating waste water along the side of the treatment tank.

17. The method of claim 14 further comprising the step of directing the activated slurry into the waste water to cause circulatory flow of the waste water within the treatment tank.

18. The method of claim 14 further comprising the step of directing the activated slurry into the waste water to stir up any settled sludge formed within the center of the treatment tank.

19. The method of claim 14 further comprising the step of lifting the system for treating waste water as a unitary structure from the treatment tank in order to perform maintenance on the system.
